(19) United States
(12) Patent Application Publication
(10) Pub. No.: US 2011/0314159 A1
(43) Pub. Date: Dec. 22, 2011

(54) SYSTEM AND METHOD OF LOCAL RESOURCE DELIVERY

(75) Inventors: William A. MURPHY, Glace Bay (CA); Gordon FREEDMAN, Ottawa (CA)

(73) Assignee: IWATCHLIFE, Ottawa (CA)

(21) Appl. No.: 13/166,310

(22) Filed: Jun. 22, 2011

Related U.S. Application Data
(60) Provisional application No. 61/357,288, filed on Jun. 22, 2010.

(51) Int. Cl. G06F 15/173

(52) U.S. Cl. 709/226

(57) ABSTRACT

A system and method are provided for resource registration and delivery. A local resource is registered on a nonlocal server with an entry which identifies the local resource and contains information for use in locally accessing the local resource. When a local client of a local network local to the local resource requests access to the local resource, the nonlocal server determines that the local client and the local resource are local to each other and provides a response for enabling direct local access by the local client to the local resource.

### FIELD OF THE INVENTION

The invention relates to communications networks, and more particularly to local streaming resource registration and delivery.

### BACKGROUND OF THE INVENTION

In network communication systems delivery of resources and or services from a source machine to a client destination requires a host of network infrastructure to ensure proper delivery of the resource when requested by the client. One type of network resource which can be bandwidth intensive and require special considerations is streaming media. Streaming video and sound require real-time transfer of data such that an uninterrupted quality of presentation is provided.

Some systems and applications by their nature require efficient and reliable delivery of real-time streaming media, for example systems for surveillance and security.

Modern security and surveillance systems have come to rely very heavily on the use of video surveillance cameras for the monitoring of remote locations, entry/exit points of buildings or other restricted areas, and high-value assets, etc. The majority of surveillance video cameras has been changing from analog cameras used in closed circuit television (CCTV) based systems to digital cameras used in today's digital video systems (DVS). In DVS, video is digitized, compressed and packetized in IP, and then streamed to a server.

Recently, IP-networked digital video systems have been implemented. In this type of system the surveillance video is encoded directly on a digital camera, in H.264 or another suitable standard for video compression, and is sent over Ethernet at a lower bit rate. This transition from analog to digital video is bringing about long-awaited benefits to security and surveillance systems, largely because digital compression allows more video data to be transmitted and stored. Of course, a predictable result of capturing larger amounts of video data is that more personnel are required to review the video that is provided from the video surveillance cameras. Advantageously, storing the video can reduce the amount of video data that is to be reviewed, since the motion vectors and detectors that are used in compression can be used to eliminate those frames with no significant activity.

This compressed video data can be sent directly to personnel for review or may first be subject to what is known as video analytics which further electronically recognizes important activity recorded within the video data and forwards data reflecting the same further down the processing/delivery path between the original video source and the data's final destination.

Regardless of the particular kinds of video data processing that are employed and where they are carried out, regardless of the size and nature of the streaming video data, and regardless of the degree of video analytics carried out on the video data or the location where this occurs, there must exist a system and method for delivering the data resource, in whatever form it takes, from each point within the processing/delivery path to its next destination i.e. next client within the processing/delivery path, where the next step of processing, analytics, viewing, recording, storing, or otherwise takes place.

FIG. 1A illustrates an example of a known system for generic resource delivery, generally indicated by 100a, to a local client destination CLIENT2 144.

The client 144 is connected to a local network 140 which also includes a second and third local client 143, 145, a first and second local server 141, 142, and a host of other local clients, servers, and network infrastructure (not shown). For access to outside networks, local gateway infrastructure 130, which is also connected to the local network 140, is used. The local gateway infrastructure 130 facilitates, manages, and may monitor communications leaving and entering the local network 140 from the outside.

The local gateway infrastructure 130 is connected by an Internet service provider (ISP) infrastructure 120 to a large public network 110 such as the Internet. Although numerous machines, clients, and servers may form part of and are connected to the large public network 110, for convenience only the first, second, third, and fourth nonlocal servers 111, 112, 113, 114 are shown.

Data files, services, streaming services and other resources delivered across networks are commonly accessed using web browsers. In the known system 100a, the local client 144 of FIG. 1A is running a web browsing application which is displaying a page divided into two frames. One frame requests delivery of one resource, DATA A, while the other frame requests delivery of another resource, DATA B.

Utilizing a URL (Universal resource locator), IP address or other addressing system, the web browser application running on the local client 144 accesses the one resource DATA A stored at the first nonlocal server 111 through the local network 140, the local gateway infrastructure 130, the ISP infrastructure 120, and the large public network 110. The web browser application also accesses the second resource DATA B, stored at the second nonlocal server 112 through the local network 140, the local gateway infrastructure 130, the ISP infrastructure 120, and the large public network 110.

FIG. 1B illustrates a known system for resource delivery 100b similar to that of FIG. 1A, providing access to DATA A stored at the first nonlocal server 111 and DATA B stored at the first local server 141.

In FIG. 1B, the local client 144 is running a web browsing application which is displaying a page divided into two frames, one of which requests delivery of DATA A and one of which requests delivery of DATA B. Since the web browser application running on the local client 144 is only provided with a URL, IP address or other standard public address for accessing data, the communication to request DATA A and DATA B passes through the local network 140 and the local gateway infrastructure 130 to the ISP infrastructure 120 which accesses DATA A from the first nonlocal server 111 in the standard manner through large public network 110 and also accesses DATA B from the first local server 141. Thus during provision of DATA A and DATA B to the local client 144, bandwidth and resources of both the local gateway infrastructure 130 and the ISP infrastructure 120 are utilized.

FIG. 1C illustrates another known system for resource delivery, generally indicated by 100c, to a local client destination CLIENT2 144.

The known system for resource delivery 100c, depicted in FIG. 1C, possesses the same networks 140, 110, servers 111, 112, 113, 114, 141, 142, clients 143, 144, 145, and local gateway infrastructure 130 as the system depicted in FIG. 1B, however, the known system for resource delivery 100c, has an ISP infrastructure 120 which includes a file server 121 and a cache database 122. In this example system, the first nonlocal server 111 has resource DATA C stored therein. As part of the operations of the ISP infrastructure 120, at various points in time, resources throughout the large public network 110, and elsewhere which are accessible by the ISP infrastructure 120, are copied and cached in the cache database 122 for access by clients via the file server 121. In the system depicted in FIG. 1C, DATA C has already been downloaded from the first nonlocal server 111 and cached in the cache database 122.

When the local client 144 sends a request for DATA C, it is passed through the local network 140 and the local gateway infrastructure 130 to the file server 121 of the ISP infrastructure 120. When the file server 121 receives the request it identifies DATA C residing in the cache database 122, and redirects the local client 144 to the copy of DATA C residing in the cache database 122 or otherwise provides the copy of DATA C to the local client 144 in answer to the request.

In the system depicted in FIG. 1C, if DATA C had resided on the first local server 141, the ISP infrastructure would have downloaded a copy of DATA C therefrom and saved it in its cache database 122. Subsequently when the local client 144 requests DATA C it does so through the local network 140 and the local gateway infrastructure 130. The ISP infrastructure 120 would then identify DATA C in the cache database 122 and would provide access to DATA C stored in the cache database 122 by the local client 144. Although ISP infrastructure 120 avoids bandwidth and use of the large public network 110 by keeping a local copy of DATA C on its cache database 122, during provision of DATA C to the local client 144, bandwidth and resources of both the local gateway infrastructure 130 and the ISP infrastructure 120 are still being utilized.

Referring once again to FIG. 1C, if DATA C residing on the first nonlocal server 111 changes more often than it is accessed, or if DATA C comprises real-time data such as a streaming video feed, then use of the file server 121 and the cache database 122 in the delivery of DATA C become less suitable than simple real-time delivery of the data directly from the first nonlocal server 111 to the local client 144. As such, the system of FIG. 1C does not contemplate redirection of streaming data to its local cache.

Each of the known systems described above utilizes resources external and internal to a local network when providing access to data or resources requested by a local client. This causes undesirable delay, needless cost, and needless use of hardware recourses when the data or resource requested by the local client resides within the local network.

### SUMMARY OF THE INVENTION

According to one aspect, the invention provides for a method of providing access to a local resource of a local network, the method comprising: registering the local resource on a nonlocal server located external to the local network, generating a registration; receiving at the nonlocal server a request for the local resource from a local client of the local network; determining that the request is for the local resource with use of the registration; determining that the local resource is local to the local client; and providing to the local client, local access to the local resource.

According to another aspect the invention provides for a system for providing access to a local resource of a local network, the system comprising: a nonlocal server located external to the local network for registering the local resource thereby generating a registration and for receiving a request for the local resource from a local client of the local network, the nonlocal server comprising: a registry for storing the registration; and a registration and redirection module for determining that the request is for the local resource with use of the registration, determining that the local resource is local to the local client, wherein the nonlocal server is for, once the registration and redirection module determines that the request is for the local resource and that the local resource is local to the local client, providing to the local client, local access to the local resource.

### BRIEF DESCRIPTION OF THE DRAWINGS

The features and advantages of the invention will become more apparent from the following detailed description of the preferred embodiment(s) with reference to the attached figures in which like features bear similar labels, and wherein:

FIG. 1A is a network diagram illustrating a known system for network resource delivery, providing access to multiple nonlocal resources;

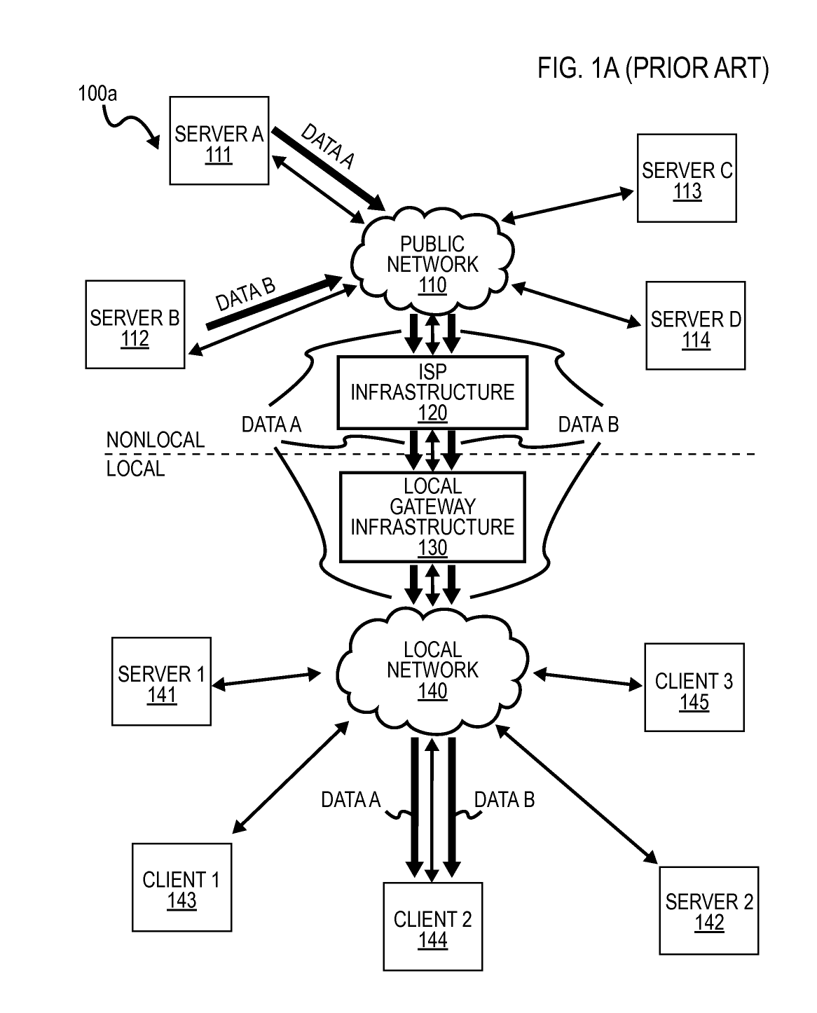

FIG. 1B is a network diagram illustrating the known system for network resource delivery of FIG. 1A providing simultaneous access to local and nonlocal resources;

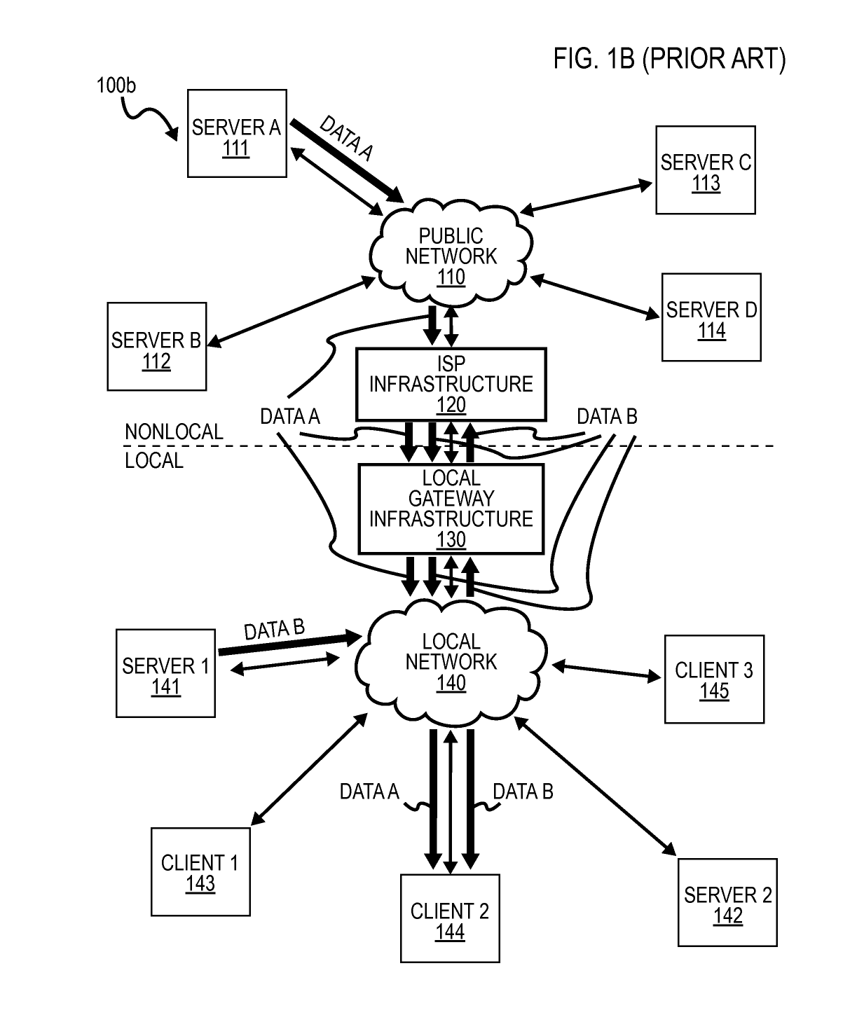

FIG. 1C is a network diagram illustrating another known system for network resource delivery;

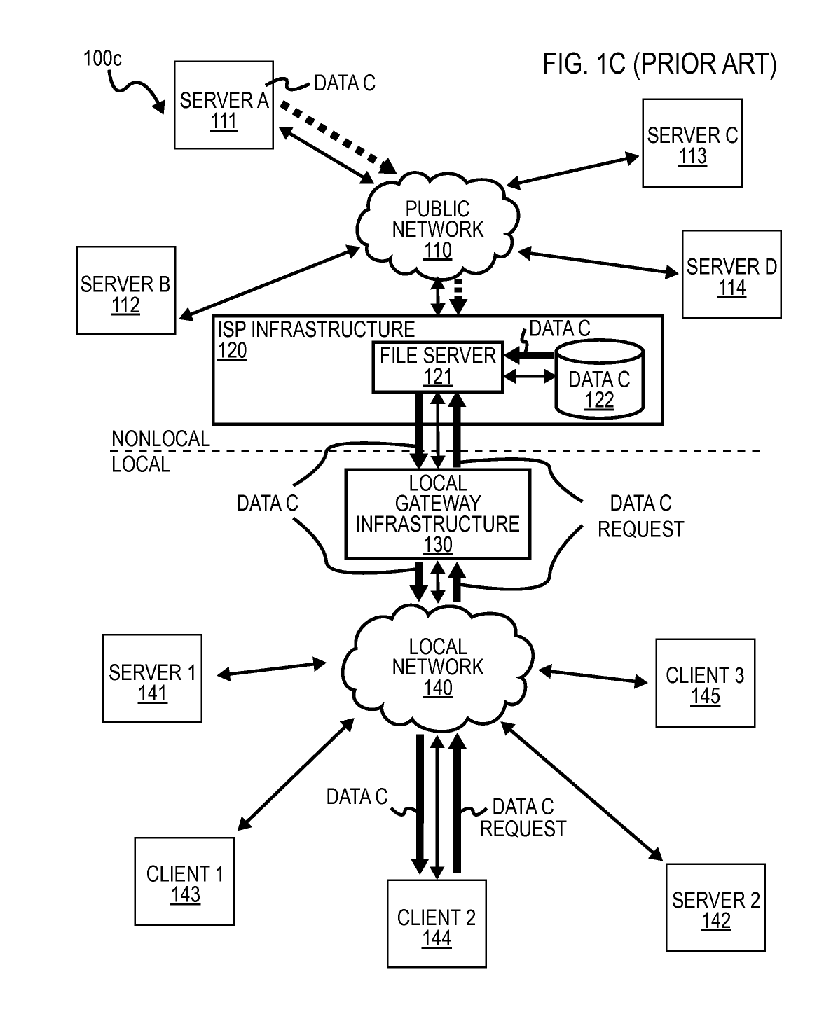

FIG. 2A is a network diagram illustrating a system for network resource delivery according to an embodiment of the invention;

FIG. 2B is a network diagram illustrating a system for network resource delivery according to another embodiment of the invention;

FIG. 3 is a functional block diagram illustrating a method for network resource delivery according to an embodiment of the invention; and

FIG. 4 is a simplified block diagram illustrating a software application screen presenting a video stream delivered according to an embodiment of the invention.

### DETAILED DESCRIPTION OF THE PREFERRED EMBODIMENTS

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

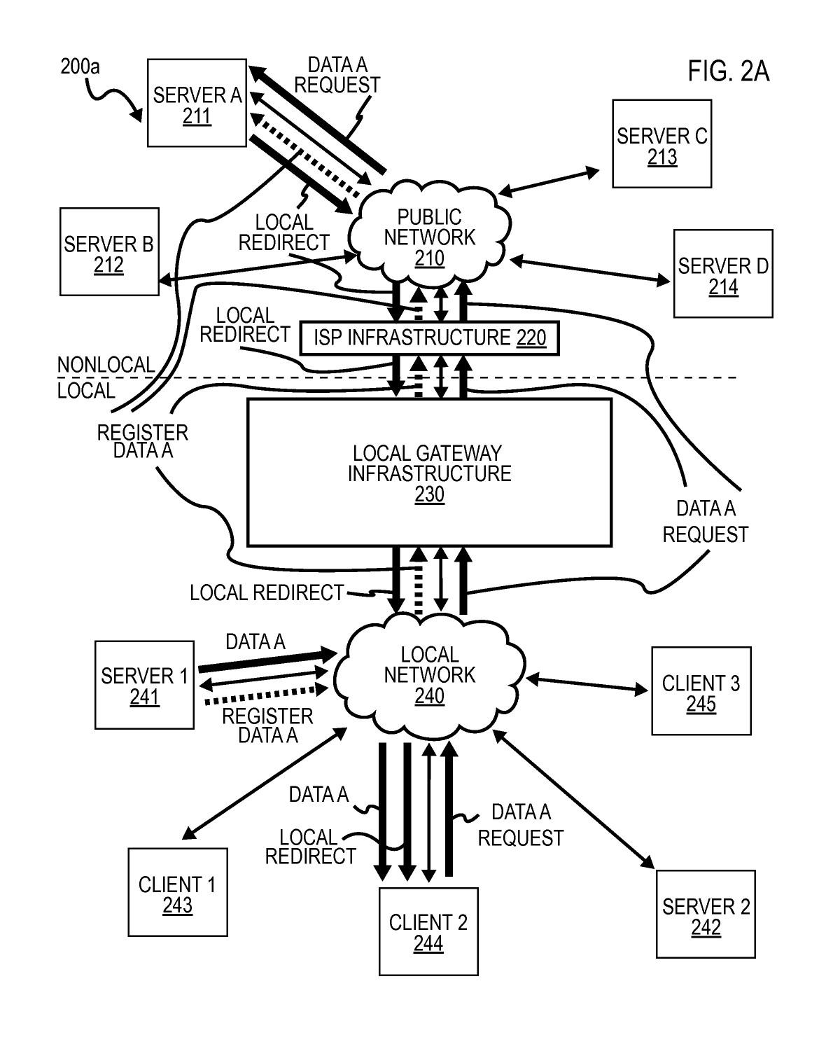

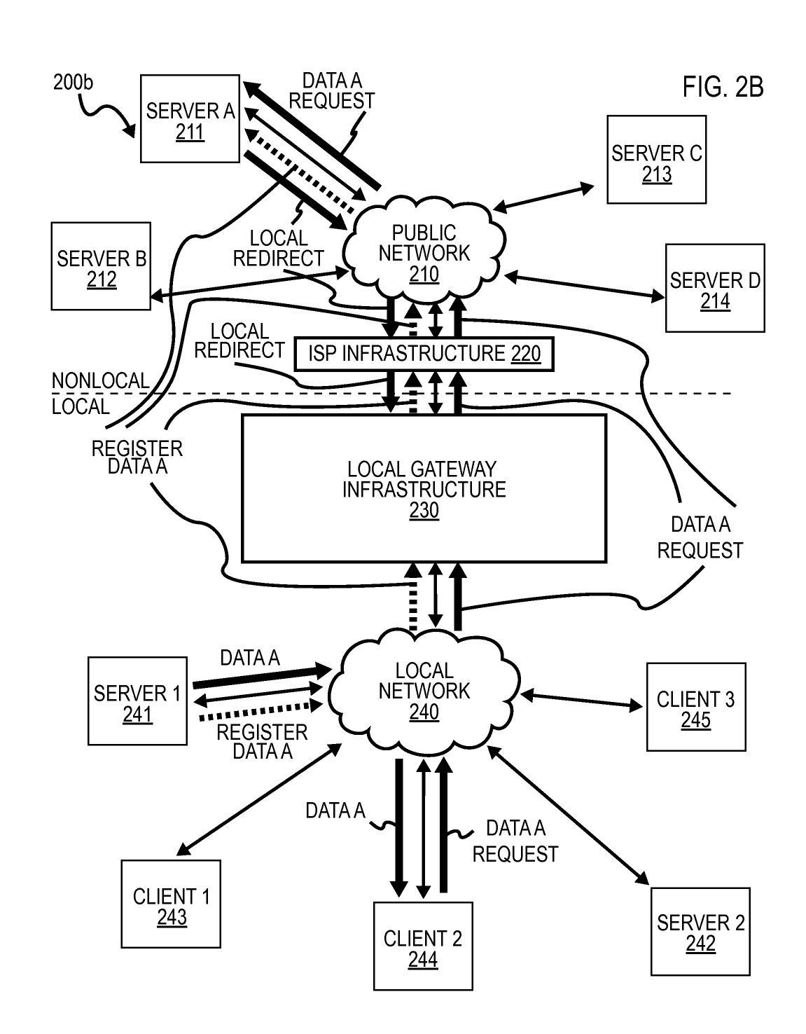

Referring to FIG. 2A, a system 200a for network resource delivery according to an embodiment of the invention will now be discussed in terms of structure. In the embodiment depicted in FIG. 2A, a local client 244 (CLIENT 2) is requesting access to a network resource DATA A during a session with a nonlocal server 211. As is discussed hereinbelow, in FIG. 2A the system 200a is performing explicit registration and delivery of resource DATA A.

The client 244 is connected to a local network 240 which also includes a local server 241 and for illustrative purposes a second and third local client 243, 245, a second local server 242, and a host of other local clients, servers, and network infrastructure (not shown). For access to outside networks, a local gateway infrastructure 230, which is also connected to the local network 249, is used. The local gateway infrastructure 230 facilitates, manages, and possibly monitors communications leaving and entering the local network 240 from the outside.

The local gateway infrastructure 230 is connected by an Internet service provider (ISP) infrastructure 220 to a large public network 210 such as the Internet. Although numerous machines, clients, and servers may form part of and are connected to the large public network 210, for convenience only a nonlocal server 211 (SERVER A), and second (SERVER B), third (SERVER C), and fourth (SERVER D) nonlocal servers 212, 213, 214 are shown.

The system 200a depicted in FIG. 2A will now be described in terms of its function.

The local client 244 sends a request for DATA A through the local network 240, the local gateway infrastructure 230, the ISP infrastructure 220, and the large public network 210 to the nonlocal server 211 on which a registration and redirection module (not shown) is situated. The registration and redirection module may be comprised of any of hardware, software, and firmware, or any combination thereof. Upon receiving the request for DATA A from the local client 244, the registration and redirection module checks in a registry (not shown) stored on the nonlocal server 211 for an entry corresponding to DATA A and containing information for access to the resource DATA A. The registration and redirection module of the nonlocal server 211 finds an entry in the registry identifying resource DATA A, and containing an explicit address or locator information for enabling local access to DATA A on local server 241 through the local network 240. Using implicit or inherent address or locator information contained within the communications signals between the nonlocal server 211 and each of the local server 241 and the local client 244, the registration and redirection module determines that the local server 241 and the local client 244 are local to each other and are both part of the local network 240. In some embodiments, the nonlocal server 211, in addition to analyzing the implicit or inherent address or locator information, analyzes the explicit address or locator information provided in the entry in the registry to establish that the local server 241 and the local client 244 are local to each other. Since DATA A is located at a local server 241 within the local network 240 which is local to the local client 244, the nonlocal server 211 replies to the request for DATA A with a local redirect message which passes through the large public network 210, the ISP infrastructure 220, the local gateway infrastructure 230, and the local network 240 and arrives at the local client 244. The local redirect message indicates to the local client 244 that the requested resource DATA A is located locally within the local network 240 and moreover provides the explicit address or locator which was registered with the registration and redirection module, this explicit address or locator being sufficient for enabling the local client 244 to directly access through the local network 240 the resource DATA A stored on the local server 241. For example, when the local server 241 comprises a video source, a World Wide Web Page is returned that retrieves data from the local server 241 for display on the local client 244.

In order for the registration and redirection module of the nonlocal server 211 to find an entry in the registry identifying resource DATA A, the resource DATA A must already be registered in the registry. This registration process is also illustrated in FIG. 2A.

In some embodiments, registration is initiated by the nonlocal server 211. In these embodiments, the nonlocal server 211 may on one time or on a periodic routine basis, initiate or request registration of resources that are available to it. In such a case, DATA A residing on the local server 241 would be registered via a register DATA A response from the local server 241 in answer to the request sent from the nonlocal server 211. The local server 241 generates a register DATA A response containing a unique identifier of the resource DATA A, and an explicit address or locator information for providing local access to DATA A by local clients. The register DATA A response sent by the local server 241 traverses the local network 240, the local gateway infrastructure 230, the ISP infrastructure 220, and the large public network 210 to arrive at the nonlocal server 211 for registration therewithin.

In some embodiments, registration is initiated by the local server 241. In these embodiments, the local server 241 registers the resource DATA A in the registry located at the nonlocal server 211 before any request for delivery of DATA A and before any request for registration from the nonlocal server 211. In accordance with these embodiments, registration could take place on a one time event triggered basis, namely, when a resource is first made available and/or when it is removed or otherwise made unavailable. In such an embodiment, the local server 241 generates a register DATA A message containing a unique identifier of the resource DATA A, and an explicit address or locator information for providing local access to DATA A by local clients. The local server 241 then sends the register DATA A message to the nonlocal server 211 through the local network 240, the local gateway infrastructure 230, the ISP infrastructure 220, and the large public network 210. As with the embodiment described hereinabove, the nonlocal server 211 processes the registration message and stores the registration information for later use.

Referring now to FIG. 2B, a system 200b for network resource delivery according to an embodiment of the invention will now be discussed. In the embodiment depicted in FIG. 2B, a local client 244 (CLIENT 2) is requesting access to a network resource DATA A during a session with a nonlocal server 211. As is discussed herein below, in FIG. 2B the system 200b is performing implicit registration and delivery of resource DATA A.

The system 200b, depicted in FIG. 2B, possesses the same networks 240, 210, servers 211, 212, 213, 214, 241, 242, clients 243, 244, 245, local gateway infrastructure 230, and ISP infrastructure 230 as the system depicted in FIG. 2A.

The system 200b depicted in FIG. 2B will now be described in terms of its function.

The local client 244 sends a request for DATA A through the local network 240, the local gateway infrastructure 230, the ISP infrastructure 220, and the large public network 210 to the nonlocal server 211 on which the registration and redirection module (not shown) is situated. Upon receiving the request for DATA A from the local client 244, the registration and redirection module checks in a registry stored on the nonlocal server 211 for an entry corresponding to DATA A and containing location information for the resource DATA A. The registration and redirection module of the nonlocal server 211 finds an entry in the registry identifying resource DATA A, and containing an implicit address or locator information for enabling local access to DATA A on local server 241 through the local network 240. Using implicit or inherent address or locator information contained within the communications signals between the nonlocal server 211 and each of the local server 241 and the local client 244, the registration and redirection module determines that the local server 241 and the local client 244 are local to each other and are both part of the local network 240. Since DATA A is located at a local server 241 within the local network 240 which is local to the local client 244, the nonlocal server 211 responds to the request for DATA A by sending a local redirect message to the local gateway infrastructure 220. The local redirect message passes through the large public network 210 and the ISP infrastructure 220 to the local gateway infrastructure 230. The local redirect message indicates to the local gateway infrastructure 230 that the requested resource DATA A is located locally within the local network 240 and moreover provides the implicit address or locator which was registered with the registration and redirection module, the implicit address or locator being sufficient for enabling the local gateway infrastructure 230 to redirect the local client's 244 request for DATA A to directly access, through the local network 240, the resource DATA A stored on the local server 241. In this embodiment, the local client 244 is not aware that the resource DATA A it is requesting and receiving is local, nor that its requests have been redirected.

In order for the registration and redirection module of the nonlocal server 211 to find an entry in the registry identifying resource DATA A, the resource DATA A must already be registered in the registry. This registration process is also illustrated in FIG. 2B.

As with the embodiments discussed in association with FIG. 2A, registration may be initiated by the nonlocal server 211, or by the local server 241. In the embodiments depicted in FIG. 2B, however, the local server 241 generates a register DATA A response or register DATA A message which only includes a unique identification of the data resource DATA A and does not include any explicit address or locator for access thereto. In such an embodiment, the nonlocal server 211 registers in its local registration database the unique identification of data resource DATA A along with an implicit or inherent address or locator which is present in the communications between the local server 241 and the nonlocal server 211 according to the communications protocol used by the local server 241 to send the register DATA A response or message and used by the nonlocal server 211 to receive the register DATA A response or message.

It should be understood, that in each of the embodiments described hereinabove and with any combination of the features thereof, the requested resource DATA A may be only one amongst many resources requested by one or more local applications running on the local client 244. Local client 244 may be running one or more Internet applications which may be displaying information and/or content from various sources at once, for example, updating security camera video streams in one frame of a webpage, displaying a blog in another frame, downloading a sports RSS feed, while streaming and playing audio from a web-radio station in the background.

In a nonlimiting example application of the use of the systems 200a and 200b depicted in FIG. 2A and FIG. 2B respectively, the local client 244 is running a video security application which accesses streamed video security feeds managed by the nonlocal server 211. In some embodiments the video security application is a stand-alone application while in other embodiments the video security application is a web enabled application executed within a web browser. The local client 244 has an identification of a resource, which identifies the video camera, source, or server, from which the local client 244 is requesting a video security feed and which corresponds to a data resource (DATA A) generated thereby. The identification uniquely identifies either the provider or the feed itself but does not in general enable the local client 244 direct access.

In this particular circumstance one of the resources is a video security feed from the local server 241. In some embodiments the local server 241 comprises a computer and associated camera while in others, the camera itself comprises sufficient digital processing to enable it to serve as the local server 241. In accordance with the description hereinabove, the video security feed has already been registered, in the nonlocal server 211. The video security application on the local client requests the video security feed by sending a request through the local network 240, the local gateway infrastructure 230, the ISP infrastructure 220, and the large public network 210 to the nonlocal server 211. The nonlocal server 211 searches its registry and finds an entry for the video security feed requested by the local client 244. The nonlocal client 211 then sends a local redirect message either through the large public network 210, the ISP infrastructure 220, the local gateway infrastructure 230, and the local network 240 to the local client 244 in a case that explicit registration and redirection is being exercised, or sends the local redirect message through the large public network 210 and the ISP infrastructure 220 to the local gateway infrastructure 230 in a case that implicit registration and redirection is being exercised. In a case of explicit redirection, the local client 244 is supplied with an explicit address or locator information for use by the local client 244 to directly access the video security feed provided by the local server 241 through the local network 240. In a case of implicit redirection, the local gateway infrastructure 230 is supplied with implicit address or locator information for use in redirecting communications from the local client 244 to the local server 241 for provision of the video security feed through the local network 240.

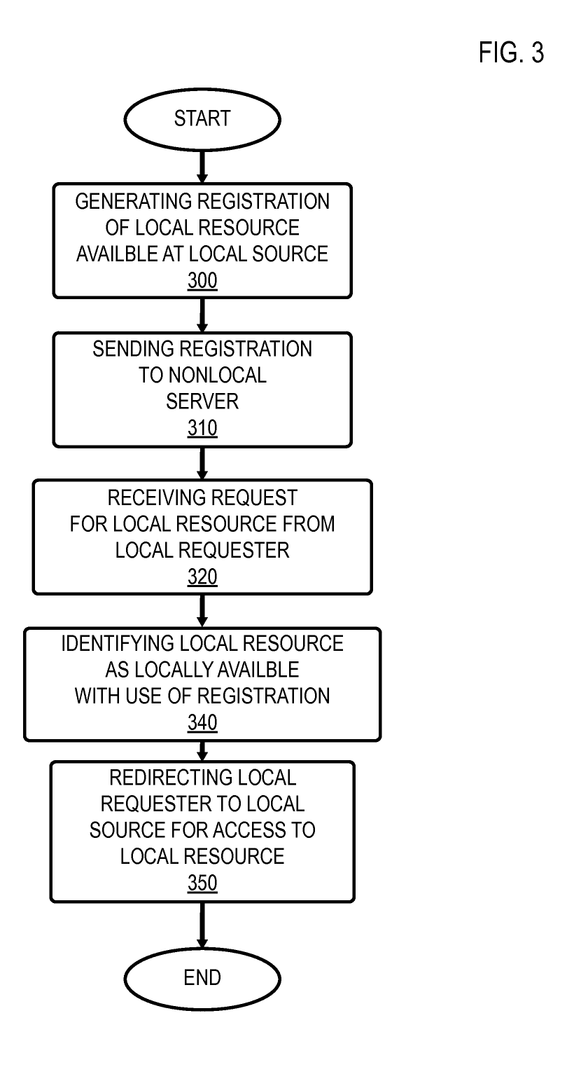

Referring to FIG. 3, a method for network resource delivery according to an embodiment of the invention will now be discussed.

At step 300, a registration of a local resource which is available at a local source is generated. This registration may be in the form of a registration response in a case that registration is in answer to a request from a nonlocal server or may be in the form of a registration message in the case that registration is initiated by the local source. As was described hereinabove the registration of the local resource includes a unique identifier identifying the local resource and may also contain an explicit address or locator information. At step 310 the registration of the local resource is sent from the local source to the nonlocal server. The nonlocal server upon receiving the registration stores it in its registry. In the event that a local requester requests the local resource, the nonlocal server receives at step 320 the request for the local resource from the local requester. At step 340 the nonlocal server searches its registry and identifies the local resource and establishes with use of inherent or explicit address and locator information that the local source and the local requester are local to each other thereby identify that the local resource is locally available to the local requester. At step 350, the nonlocal server either sends the local requester or a local gateway infrastructure the explicit or respectively inherent address and locator information thereby enabling redirection of the local requester to the local source for access to the local resource.

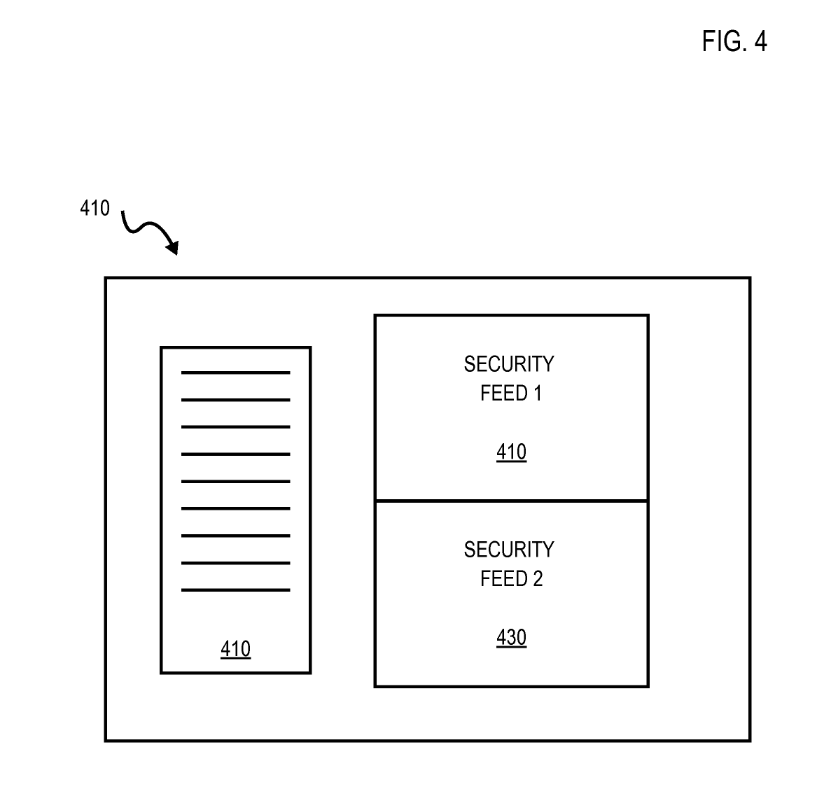

Referring to FIG. 4, shown is a simplified block diagram of a software application screen displaying a video stream delivered according to an embodiment of the invention as described hereinabove. The software application screen 400 is displaying a webpage which comprises three frames areas, each of which presents different data from a different source. In a first area 410 of the webpage is displayed a frame presenting surveillance statistics data, while in a second area are displayed a first video monitoring frame 420 in which a first security feed is displayed and a second video monitoring frame 430 in which a second security feed is displayed. It is known that the content of each frame of a multiframe webpage may come from different sources. In the example software application screen 400 of FIG. 4, the first video monitoring frame 420 accesses the first security feed which is generated at a local camera and is provided locally through the local network, while the second video monitoring frame 430 accesses the second security feed which happens to be generated from a nonlocal camera and is provided through a public network, ISP infrastructure, local gateway infrastructure, and the local network to the local client on which the software application is running. As described hereinabove, a request from a nonlocal server for the local resource, namely, the first security feed causes an implicit or explicit redirection so that the software application running on the local client retrieves the video data from the local network without that data traversing the public network en route to the client video monitor.

One application for use of the invention as described above which can potentially save a very large amount of bandwidth, resources and hence cost is one in which the resource that is redirected comprises streaming media from a local multicast IP address which is serving N local clients and may also serve a number of nonlocal clients. When the system and method as described above are applied to this case, an unnecessary bandwidth of 2*N*{bandwidth of a single stream} (since the stream would need to be uploaded and downloaded N times), which would otherwise burden both the local gateway infrastructure and the ISP infrastructure, is avoided.

Each of embodiments described above mitigates the use of resources external to the local network when providing access to data or resources located locally to a local client. This mitigates undesirable delay and needless costs and use of hardware recourses since the data or resource requested by the local client resides within the local network, and need not be sent to and retrieved from an external system which does not use or modify the data or resource in any way.

Although an example application of the embodiments of FIGS. 2B and 2C has been described in the context of the provision of a video security stream, it should be understood that the local server 241 may be providing any type of streaming media, or alternatively derivative streaming data, which may have originally been audio or video but may now comprise information regarding an analysis or security analytics process exercised thereon. As stated hereinabove it should be understood that regardless of the form of the data or what part of the security data processing/delivery path the method or system is applied to, registration and delivery of that data may be provided by the method or system as described hereinabove.

The embodiments presented are exemplary only and persons skilled in the art would appreciate that variations to the embodiments described above may be made without departing from the spirit of the invention. The scope of the invention is solely defined by the appended claims.

What is claimed is:

1. A method of providing access to a local resource of a local network, the method comprising:
registering the local resource on a nonlocal server located external to the local network, for generating a registration;
receiving at the nonlocal server a request for the local resource from a local client of the local network;
determining that the request is for the local resource with use of the registration;
determining that the local resource is local to the local network; and
providing to the local client, local access data for the local resource.

2. A method according to claim 1 wherein local access data comprises data for accessing the local resource only via the local network.

3. A method according to claim 2 wherein the registration comprises a unique identifier for identifying the local resource.

4. A method according to claim 3 wherein the registration comprises one of an address and locator information for providing local access by a local client to the local resource.

5. A method according to claim 4 wherein the one of an address and locator information is explicit.

6. A method according to claim 4 wherein the one of an address and locator information is implicit.

7. A method according to claim 4 wherein registering the local resource comprises:
receiving at the nonlocal server the unique identifier of the local resource; and
storing the unique identifier in an entry of a registry.

8. A method according to claim 7, wherein the one of an address and locator information is explicit, and wherein registering the local resource further comprises storing the one of an address and locator information in the registration with the unique identifier of the local resource.

9. A method according to claim 7, wherein determining that the request is for the local resource with use of the registration comprises comparing unique identifiers of entries in the registry with information in the request identifying the local resource.

10. A method according to claim 4, wherein determining that the local resource is local to the local network comprises comparing one of an implicit address and implicit locator information contained within communication signals from a local source of the local resource with a corresponding one of an implicit address and implicit locator information contained within communication signals from the local client.

11. A method according to claim 4, wherein providing to the local client, local access to the local resource comprises sending a local redirection message from the nonlocal server to the local client wherein the local redirection message comprises information sufficient to enable local access to the local resource by the local client.

12. A method according to claim 11, wherein the local redirection message comprises at least one of an explicit address and explicit locator information which enables local access to the local resource.

13. A method according to claim 4 wherein the local resource comprises streaming media.

14. A method according to claim 13 wherein the local client comprises a security application and the local resource comprises a security video stream for use by the security application.

15. A method according to claim 11, wherein the local redirection message comprises a web page including a frame, the frame content for being retrieved from an external source, the external source addressed with a network address local to the local network.

16. A system for providing access to a local resource of a local network, the system comprising:
a nonlocal server located external to the local network for registering the local resource thereby generating a registration and for receiving a request for the local resource from a local client of the local network, the nonlocal server comprising:
a registry for storing the registration; and
a registration and redirection module for determining that the request is for the local resource with use of the registration, determining that the local resource is local to the local client and for, once determined that the request is for the local resource and that the local resource is local to the local network, providing to the local client, local access to the local resource.

17. A system according to claim 16 wherein local access comprises access only via the local network.

18. A system according to claim 17 wherein the registration comprises a unique identifier for identifying the local resource.

19. A system according to claim 18 wherein the registration comprises one of an address and locator information for providing local access by a local client to the local resource.

20. A system according to claim 19 wherein the one of an address and locator information is explicit.

21. A system according to claim 19 wherein the one of an address and locator information is implicit.

22. A system according to claim 19 wherein the nonlocal server is for registering the local resource by:
receiving the unique identifier of the local resource in one of a resource register request and a resource register message; and
storing the unique identifier in the registry.

23. A system according to claim 22, wherein the one of an address and locator information is explicit, and wherein the nonlocal server is for registering the local resource by storing the one of an address and locator information in the registration with the unique identifier of the local resource.

24. A system according to claim 22, wherein the registration and redirection module determines that the request is for the local resource with use of the registration by comparing unique identifiers of entries in the registry with information in the request identifying the local resource.

25. A system according to claim 19, wherein the registration and redirection module determines that the local resource is local to the local client by comparing one of an implicit address and implicit locator information contained within communication signals from a local source of the local resource with a corresponding one of an implicit address and implicit locator information contained within communication signals from the local client.

26. A system according to claim 19, wherein the nonlocal server provides to the local client, local access to the local resource by sending a local redirection message to the local client wherein the local redirection message comprises information sufficient to enable local access to the local resource by the local client.

27. A system according to claim 26, wherein the local redirection message comprises at least one of an explicit address and explicit locator information which enables local access to the local resource.

28. A system according to claim 19 wherein the local resource comprises streaming media.

29. A system according to claim 28 wherein the local client comprises a security application and the local resource comprises a security video stream for use by the security application.
